(19) United States
(12) Patent Application Publication
(10) Pub. No.: US 2011/0202468 A1
(43) Pub. Date: Aug. 18, 2011

(54) Customizing an Extensible Markup Language Standard for Technical Documentation

(76) Inventors: Dan Crowell, Rockwall, TX (US); Rick Schochler, Keller, TX (US); Don Smith, Grand Prairie, TX (US)

(21) Appl. No.: 12/706,924

(22) Filed: Feb. 17, 2010

(51) Int. Cl. G06F 17/00; G06Q 10/00; G06F 3/048

(52) U.S. Cl. 705/301; 715/234; 715/764

(57) ABSTRACT

A system, method, and computer program product are provided for customizing an extensible markup language standard for technical documentation. Preliminary analysis is conducted for a project associated with the extensible markup language specification for technical data. A user interface inputs multiple preliminary decisions based on the preliminary analysis, wherein each of the multiple preliminary decisions corresponds to one of multiple prompts associated with the extensible markup language specification for technical data. The user interface provides access for multiple project representatives to the multiple preliminary decisions. A preliminary decision of the multiple preliminary decisions is converted to a decision based on a user input via the user interface. The user interface may output a report based at least on the decision. A data module may be generated based at least on the decision, wherein the data module may be executed to process technical data associated with the project.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO MICROFICHE APPENDIX

Not applicable

### FIELD OF THE PRESENT DISCLOSURE

The embodiments of the present disclosure relate generally to customizing a markup language standard for use with specific data, and more specifically to a system, method, and computer program product for customizing the S1000D™ specification for documenting specific technical design projects.

### BACKGROUND

Extensible Markup Language (XML) is a set of rules for encoding documents electronically and is a subset of the Standard Generalized Markup Language (SGML). These rules are defined in the XML 1.0 Specification produced by the World Wide Web Consortium and several other related specifications. XML's design goals emphasize simplicity and usability over the Internet. XML is a textual data format with strong support via the Unicode™ computing industry standard for the languages of the world. Although XML's design focuses on documents, it is widely used for the representation of arbitrary data structures, for example in web services. There are a variety of programming interfaces which software developers may use to access XML data, and several schema systems designed to aid in the definition of XML-based languages.

S1000D™ is an international SGML/XML standard for creating, managing, storing, and exchanging technical documentation, such as documentation for equipment maintenance and operations information. S stands for standard, 1000 is inspired by the Dewey decimal classification of human knowledge, and D stands for documentation. S1000D™ was initially developed by the AeroSpace and Defence Industries Association of Europe (ASD) for use with military aircraft. The standard has since been modified for use with land, sea, and commercial equipment. The S1000D™ specification is maintained by the Technical Publications Specification Maintenance Group, which includes board members from ASD, the United States' Aerospace Industries Association, and the Air Transport Association, along with national industry and defense representatives from many of the countries currently using the standard.

S1000D™ compliance is being mandated in contracts with increasing frequency, rapidly becoming the de facto standard for technical documentation throughout the world. S1000D™ requires that a document be broken down into individual data items which can be marked with individual XML labels and be part of a hierarchical XML structure. This hierarchy permits the updating of single data items without necessarily changing the path down the XML tree which points to them. Knowledge so partitioned and classified can therefore be shared among many documents, such that updating of data items in an underlying S1000D™ document will automatically effect updating of the dependent documents. The core S1000D™ principle of information reuse, or data module, produces information structured in ways that make it deliverable in a wide variety of electronic formats, as well as traditional printed manuals. S1000D™ projects typically require that a database be skillfully populated with tens of thousands of reusable components that can instantly be assembled into cohesive and accurate electronic guides. There is still a paramount authoring function to be performed, but it may be a task devoid of traditional formatting concerns that may be stipulated in, and controlled by, project style sheets. An actual XML hierarchy may be designed specifically for each different knowledge domain or design project.

In order to implement S1000D™, a project developer may make decisions about each of the nearly one thousand S1000D™ business rules. Although a project developer may begin the process using its own employees as analysts, typically project developers hire outside consultants who provide analysts to begin this process. Due to nearly one thousand business rules and their corresponding decision points in the S1000D™ specification, this process typically requires preliminary analysis based on collaboration between the analysts and project representatives, such as subject matter experts, business managers, and project stakeholders. Based on the preliminary analysis, which may evaluate the current project, who is involved with the current project, and what data sets are required for the current project, the analysts may determine which of the nearly one thousand business rules in the S1000D™ specification apply to the current project. For example, the decision points described by the business rules in chapter 8.2.6 for tactical missiles in the S1000D™ specification may not apply to all design projects. The analysts may enter each of the decision points that correspond to the applicable business rules into a document, for example by manually entering the corresponding decision points into a spreadsheet document or copying the corresponding decision points from the S1000D™ specification and pasting these decision points into a word processor document.

The project developer may select which project representatives review each of the decision points in the analyst-created document and consult on the decision for each of these decision points. After consulting on the decision for each of the decision points, the project representatives may agree upon a decision and enter the decision into the analyst-created document. The completed version of the analyst-created document may serve as a report of the decisions that correspond to each of the applicable S1000D™ business rules for the current project. If the analyst-created document is a spreadsheet, the spreadsheet may be converted to a word processor document to enhance readability of the report.

XML coders may use the completed version of the analyst-created document to code a business rule exchange (BREX) data module for the current project by entering an XML path (XPath) language statement for each decision into an XML editor. The XML coders may use test data to test the coded business rule exchange data module. Subsequent to the completion of successful testing, an XML schema for S1000D™ may initially validate whether input is valid when a project developer enters the input to create a document for the current project. If the XML schema for S1000D™ determines that the input is valid, the business rule exchange data module may also validate whether the input is valid. If both the XML schema for S1000D™ and the business rule exchange data module determine that the input is valid, the input may be accepted for the document. If the input is not accepted for the document, an error message may be output to the project developer.

Project developers may be stymied by the daunting challenge of conforming to the thousands of pages of S1000D™ requirements. Authoring is still content-centric, but with new and unfamiliar rules. There is a need for improvements to the complex process for customizing the S1000D™ specification for specific technical projects.

### SUMMARY

A system, method, and computer program product are provided for customizing an extensible markup language standard for technical documentation. In contrast to spending weeks of preliminary analysis to determine which business rules apply to a project and manually entering the corresponding decision points into a document, analysts conduct preliminary analysis to determine preliminary decisions for each business rule or decision point that is displayed by a computer program and enter the preliminary decisions into the computer program. Instead of the project representatives taking many months or even years to travel to and attend face-to-face meetings for making decisions about each of the applicable business rules or decision points, the project representatives quickly review the analysts' preliminary decisions displayed by the computer program. Rather than taking months or years to identify one possible decision out of countless possible decisions for a business rule, a project representative may quickly confirm an analyst's preliminary decision or use the analyst's preliminary decision as the basis for proposing an alternative decision. The computer program may convert each preliminary decision to a decision for a business rule based on either confirmation or modification of the preliminary decision. As an alternative to an XML coder manually coding a statement for each decision printed on a word processor document, the computer program may display each decision individually to prompt the XML coder to systematically code a statement for each decision. The computer program may generate a data module based on the statements coded for the decisions, such that the customized data module may be executed to process technical data associated with the specific project. The customized data module may be generated by a process that is significantly less time-consuming and more error-free than the current processes for customizing the S1000D™ specification for technical documentation.

### BRIEF DESCRIPTION OF THE DRAWINGS

Drawings of the preferred embodiments of the present disclosure are attached hereto so that the embodiments of the present disclosure may be better and more fully understood:

FIG. 1 presents a sample system of the present disclosure;

FIG. 2 presents a sample frame of a display screen presented by the user interface of the present disclosure;

FIG. 3 presents another sample frame of another display screen presented by the user interface of the present disclosure;

FIG. 4 presents yet another sample frame of yet another display screen presented by the user interface of the present disclosure; and

FIG. 5 presents a sample method of the present disclosure.

### DETAILED DESCRIPTION OF SOME EMBODIMENTS

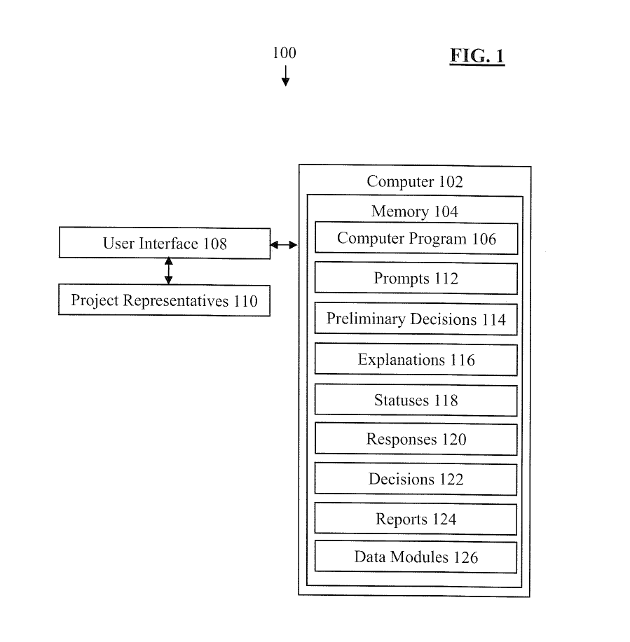

FIG. 1 presents a sample system 100 of the present disclosure. The system 100 includes a computer 102, a memory 104, a computer program 106, and a user interface 108. The computer program 106 is stored in the memory 104 and executed by the computer 102 to communicate via the user interface 108 with project representatives 110. Although FIG. 1 depicts that the memory 104 may also include prompts 112, preliminary decisions 114, explanations 116, statuses 118, responses 120, decisions 122, reports 124, and data modules 126, the elements 112-126 may reside in a separate data storage (not depicted in FIG. 1) or any combination of the elements 112-126 may reside in any combination of the memory 104 and the separate data storage. Although FIG. 1 depicts one of each of the elements 102-126, the system 100 may include any number of each of the elements 102-126.

Although examples describe the extensible markup language standard as the S1000D™ specification, some embodiments of the present disclosure may use another extensible markup language standard. The S1000D™ specification may include nearly one thousand business rules, but a project developer may create additional customized business rules that are not included in the S1000D™ specification. In embodiments of the present disclosure, analysts do not spend weeks of preliminary analysis only for the purpose of determining which business rules apply to a project and manually entering the corresponding decision points, or prompts 112, into a document. Instead, an analyst conducts preliminary analysis to determine the preliminary decisions 114 for each prompt 112 that is displayed via the user interface 108. The more experience that the analyst has with the S1000D™ specification and the subject matter of the current project; the greater the percentage may be of the preliminary decisions 114 that are confirmed to become the decisions 122. The computer program 106 may conduct preliminary analysis by prompting an analyst to consult with the project representatives 110 about a S1000D™ project.

The analysts may enter the preliminary decisions 114 into the computer program 106 via the user interface 108, with each of the preliminary decisions 114 corresponding to one of the prompts 112. Any of the preliminary decisions 114 may include a request for further analysis. For example, the preliminary decision for the choice of language may include a request for a project stakeholder to determine to which countries the results of the project may be leased or sold.

Each of the preliminary decisions 114 may correspond to a phase of a project, with the phase of the project corresponding to a subset of the prompts 112. For example, the analysts may identify a subset of the business rules that may be applicable during the initial stages of a project. The analysts may submit preliminary decisions for each of this subset of business rules to enable XML coders to author rules that result in coding a data module based on the decisions that correspond to these submitted preliminary decisions. This phased approach may enable the project developer to develop specific documentation for the initial phases of the project while the analysts continue with the preliminary analysis to determine the preliminary decisions for the remaining business rules. Upon the completion of the preliminary analysis and the evaluation of the remaining preliminary decisions, XML coders may author rules to code an additional data module based on the decisions for the remaining project phases or author rules to incorporate the decisions for the remaining project phases into the data module coded for the initial phases of the project.

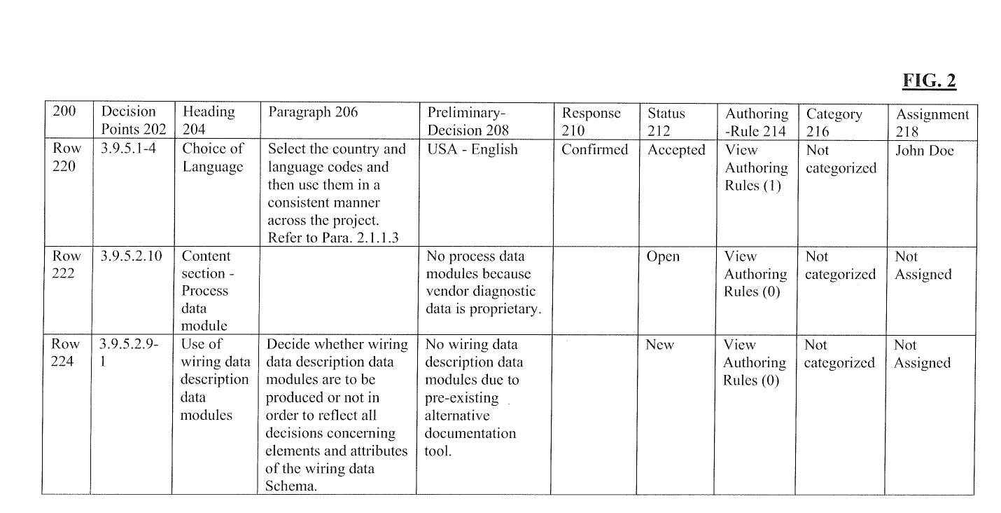

The user interface 108 provides access for the project representatives 110 to the preliminary decisions 114, where access may be based on acceptance of access-enabling information, such as user identifications and passwords, input via the user interface 108. In embodiments of the present disclosure, geographically dispersed project representatives 110 do not need to take many months or even years to travel to and attend face-to-face meetings for making the decisions 120 about each of the applicable business rules. Instead, the project representatives 110 may concurrently use this specified access to quickly review the preliminary decisions 114 via the user interface 108 even if the project representatives work in significantly different time zones. The user interface 108 may display the explanations 116 for each of the preliminary decisions 114 with the corresponding preliminary decisions 114. Examples of the explanations 116 are described below in reference to FIG. 2.

In embodiments of the present disclosure, project representatives do not have to take months or years to identify one possible decision out of countless possible decisions for a business rule. Instead, any of the project representatives 110 may use the user interface 108 to enter any of the responses. 120 to confirm any of the preliminary decisions 114 or use any of the preliminary decision 114 as the basis for proposing an alternative decision. The user interface 108 may also display justifications from the project representatives 110 for each proposed alternative decision with the corresponding proposed alternative decision that is submitted in a response. The user interface 108 may also convey an explanation from an analyst to any of the project representatives 110 for any reasons to retain any of the preliminary decisions 114. When the analysts and the project representatives 110 collaborate to reach an agreement, each of the preliminary decisions 114 may be converted to the decisions 122 based on either confirmation or modification of the preliminary decisions 114 via the responses 120 input into the user interface 108. The user interface 108 may convey the statuses 118 in real-time, wherein each of the statuses 118 corresponds to one of the preliminary decisions 114. Examples of the statuses 118 are described below in reference to FIG. 2. The user interface 108 may assist in the collaborative process by conveying the entry of the preliminary decisions 114 and each of the project representative's responses 120 to each of the project representatives 110 and each of the analysts in real-time or near real time. Therefore, a project representative in New York may instantly review a response made by a project representative in Los Angeles to a preliminary decision.

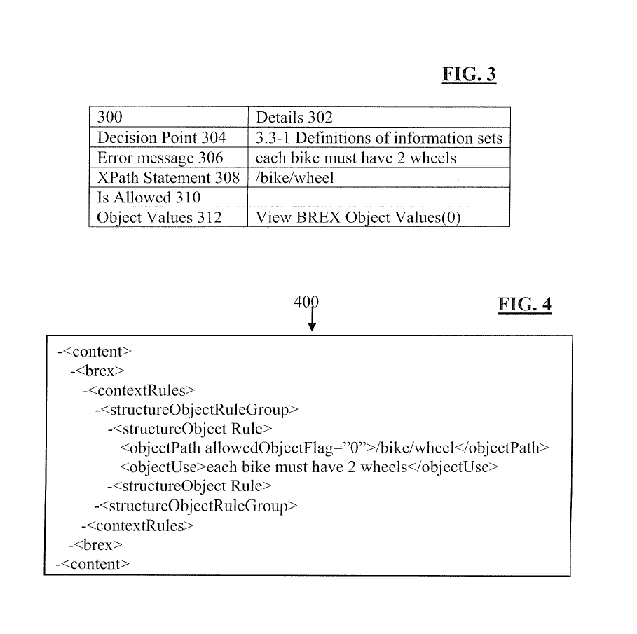

The user interface 108 may output any of the reports 124 based at least on the decisions 122, such as a word processor report, an XML report, a hypertext markup language (HTML) report, or a portable document format (PDF) report. In embodiments of the present disclosure, an XML coder may not need to manually enter an XML path language statement for each decision printed on a report that is a word processor document, which is a tedious and error-prone process. Instead, the user interface 108 displays each of the decisions 122 to enable the XML coder to systematically enter an XML path language statement for each of the decisions 122. An example of a XML coder authoring an XML path language statement is described below in reference to FIG. 3.

The computer program 106 may generate any of the data modules 126, such as a business rules exchange data module, based on XML path language statements entered via the user interface 108 for the decisions 122, where each of the decisions 122 may be traced back to a corresponding business rule in the S1000D™ specification. An example of a portion of a business rules exchange data module is described below in reference to FIG. 4. The computer program 106 may generate any of the data modules 126 based on the user interface 108 prompting an XML coder to enter an XML path language statement based on each of the decisions 122.

The data modules 126 may specify an information code that may be based on a preliminary decision and/or a decision. For example, if a diagnostic procedure requires that a component be removed and replaced, an XML coder may substitute “600 remove component” and “700 replace component” for the initially submitted instructions of “remove component” and “replace component.” Many technicians working in the field may already equate the information code 600 with the instruction “remove” and the information code 700 with the instruction “replace.” The computer program 106 may access a cross-referencing database to enable an XML coder to determine which information codes correspond to which instructions.

The computer program 106 may output a prompt to execute any of the data modules 126 to process technical data associated with the project. The data modules 126 may be executed by the project developer's computer and computer program rather than the computer 102 and the computer program 106 that generated the data modules 126. As described above, a project developer's input may be accepted for a document if both the XML schema for S1000D™ and the data modules 126, such as a business rule exchange data module, determine that the input is valid. However, embodiments of the present disclosure may enable the generation of a customized data module in a process that is significantly less time-consuming and more error-free than the typical process for customizing the S1000D™ specification for specific projects.

FIG. 2 presents a sample frame 200 of a display screen presented by the user interface 108 of the present disclosure. The frame 200 includes a decision points column 202, a heading column 204, a paragraph column 206, a preliminary-decision column 208, a response column 210, a status column 212, an authoring-rule column 214, a category column 216, an assignment column 218, and rows 220, 222, and 224. The row 220 depicts data in the columns 202-218 that is related to the choice of a language, the row 222 depicts data in the columns 202-218 that is related to the use of process data modules, and the row 224 depicts data in the columns 202-218 that is related to the use of wiring data description data modules.

The intersection of the decision points column 202 and the row 220 depict that the subject matter for row 220 is the 4^{th} decision point in chapter 3.9.5.1 in the S1000D™ specification. The intersection of the heading column 204 and the row 220 depict that the choice of language is the subject matter for row 220. The intersection of the paragraph column 206 and the row 220 depict a summary of the guidance in the S1000D™ specification for the choice of language.

The intersection of the preliminary decision column 208 and the row 220 depict that an analyst entered “USA—English” for the choice of language, which may be because the current project is for an aircraft that is to developed and used exclusively in the United States of America. Although the analyst may enter an explanation that may be displayed in the preliminary-decision column 208, the analyst may have the option of omitting an explanation for a preliminary decision. The intersection of the response column 210 and the row 220 depict that a project representative entered “confirmed” for the choice of language, which may be because the project representative is a stakeholder who confirmed that the current project is for an aircraft that is to developed and used exclusively in the United States of America. If the project representative preferred an alternative decision to the preliminary decision offered by the analyst, the intersection of the response column 210 and the row 220 may depict the alternative decision and any justification that the project representative offered to convince the analyst of the reasons why the project representative preferred the alternative decision. In such situations, the analyst and the project representative may communicate via the columns 208 and 210 and/or communicate external to the frame 200 until the analyst and the project representative collaboratively reach agreement on the decision for the decision point in question.

The intersection of the status column 212 and the row 220 depict that the agreement between the analyst and the project representative resulted in an “accepted” status for the choice of language decision point. The intersection of the authoring-rule column 214 and the row 220 depict that the accepted status for the choice of language resulted in an XML coder authoring one rule for the choice of language, such that the rule may be viewed by selecting the intersection of the authoring-rule column 212 and the row 220. The intersection of the category column 216 and the row 220 depict that the decision for the choice of language has not been categorized as to whom the decision for the choice of language applies. Not every decision may apply to every aspect of technical documentation. Examples of to which aspect a decision may be applied include authoring, illustration, publishing, supplier management, remote authoring, configuration control, and workflow management. The intersection of the assignment column 218 and the row 220 depict that “John Doe” is the project representative assigned to the choice of language.

The user interface 108 may convey a suggestion to correct any of the decisions 122 that promotes a correction of the decisions 122. For example, although the XML coder has already authored a rule for USA English as the choice of language, if John Doe subsequently completes negotiations to sell the result of the project to the British and French governments, he can modify the decision of USA English as the only choice of language. Because this decision had already been confirmed and accepted, the modified decision may result in a status of “correction.” A correction status may alert other project representatives to review the correction via the frame 200, and may prompt an XML coder to author a new rule to also support both the British spelling of English and the dialect of French used in France as the choices of language.

The user interface 108 may output display screens that depict data for an individual decision point, such as the data for the row 220, and/or data for chapters of decision points, which may list each chapter, the number of decisions for each chapter, the number of corrections for each chapter, and corresponding links for the decisions and corrections. FIG. 2 depicts the frame 200 as including both data for an individual decision point, such as the row 220, and data for a chapter, such as the row 222. The data in the row 222 indicates that the analyst recommended that no data process modules be used in the project because the analyst determined that the diagnostic data needed from vendor devices is proprietary. A process data module is a data module that bases its output on dynamic inputs from hardware and/or user responses, such as the oil pressure and the speed of an engine. Process data modules may be very helpful in enabling a technician to quickly diagnose a problem for a piece of equipment. However, the process of acquiring all of the necessary input data may be complicated by vendors whose diagnostic interfaces convey their data in a proprietary format that a process data module may not be able to interpret.

The data in the row 224 indicates that an analyst determined that no wiring data description data modules would be used for the project because wiring documentation is already available via an alternative documentation tool that is not compatible with the S1000D™ specification. Such an analyst determination may save considerable time in customizing the S1000D™ specification for a project because this preliminary decision may pre-empt the need to determine preliminary decisions for more than 200 decision points that are related to documenting wiring data.

The frame 200 may be part of a larger display screen that includes fields for users to enter search criteria, such as searches based on categories, chapters, statuses, and assignments. The user interface 108 may output a display screen that includes the frame 200 in response to a search based on search criteria input via the user interface 108. For example, a project representative may request to view all of the preliminary decisions 114 with a “new” status so that the project representative may review the most recent preliminary decisions 114 from the analysts. In another example, a project representative may request to view all of the preliminary decisions 114 that are assigned to the project representative so that the project representative may become certain that all of the requested responses 120 are provided.

FIG. 3 presents another sample frame 300 of another display screen presented by the user interface 108 of the present disclosure. The frame 300 includes a detail column 302, a decision point row 304, an error message row 306, an XPath statement row 308, an is allowed row 310, and an object values row 312. The frame 300 may be part of a larger display screen that enables an XML coder to author rules for the decisions that correspond to each applicable business rule. For example, the intersection of the details column 302 and the decision point row 304 identifies a specific decision point and its chapter in the S1000D™ specification. In another example, the intersection of the details column 302 and the error message row 306 initially indicate the decision for the specified decision point is that “each bike must have 2 wheels,” which may serve as the basis for both the XML path language statement entered by an XML coder for the decision and the basis for the error statement that responds to entries that violate the XML path language statement entered by an XML coder. In yet another example, the intersection of the details column 302 and the XPath statement row 308 is the XML path language statement entered by an XML coder for the specified decision point. In a further example, the intersection of the details column 302 and the is allowed row 310 is the option to specify “all,” “true,” or false” for the specified decision point. In one more example, the intersection of the details column 302 and the Object Values row 312 enables the specification of the possible entry options for the specified decision point. By prompting XML coders with decisions, enabling the tracing of the decision to the corresponding business rule, and inputting the XML path language statements entered in response, the user interface 108 enables XML coders to systematically author rules in a structured environment that may result in the generation of a business rule exchange data module that contains relatively few errors.

In another example, which is not depicted in FIG. 3, an XML coder may determine which attributes are acceptable for a project developer to enter when specifying the manufacturer for the string <part_number mfg=“ ”>. The XML coder may author a rule that enables the project developer to enter virtually anything to specify the manufacturer if an unknown number of manufacturers may supply the specified part. Alternatively, the XML coder may author a rule that enables the project developer to enter only manufacturers from a list of approved manufacturers who supply the specified part.

Because the frames 200 and 300 are samples, the frames 200 and 300 could vary greatly in appearance. For example, the relative sizes and positioning of the columns and rows is not important to the practice of the present disclosure. The frames 200 and 300 can be depicted by any visual display, but are preferably depicted by a computer screen. The frames 200 and 300 can be part of a personal computer system and/or a network, and operated from data received locally, by the network, and/or on the Internet. The frames 200 and 300 may be navigable by a user. Typically, the user can employ a mouse input device to point-and-click to a location on the frames 200 and 300 to manage the data on the frames 200 and 300, such as the selection of fields or icons that enable the editing of the data. Alternately, the user can employ directional indicators, or other input devices such as a keyboard. The data depicted by the frames 200 and 300 are examples, as the frames 200 and 300 may have a much larger number of rows and/or columns. Note that although the text as shown is located in some parts of the frames 200 and 300, in another embodiment the text could be located in other parts of the frames 200 and 300. The frames 200 and 300 also include fields in which the user can input textual information, such as intersections of rows and columns for entering responses and XML path language statements.

FIG. 4 presents yet another sample frame 400 of yet another display screen presented by the user interface 108 of the present disclosure. The frame 400 is a sample of the output generated by the computer program 106 executing one of the data modules 126, specifically the business rules exchange data module based on the data specified in the frame 300.

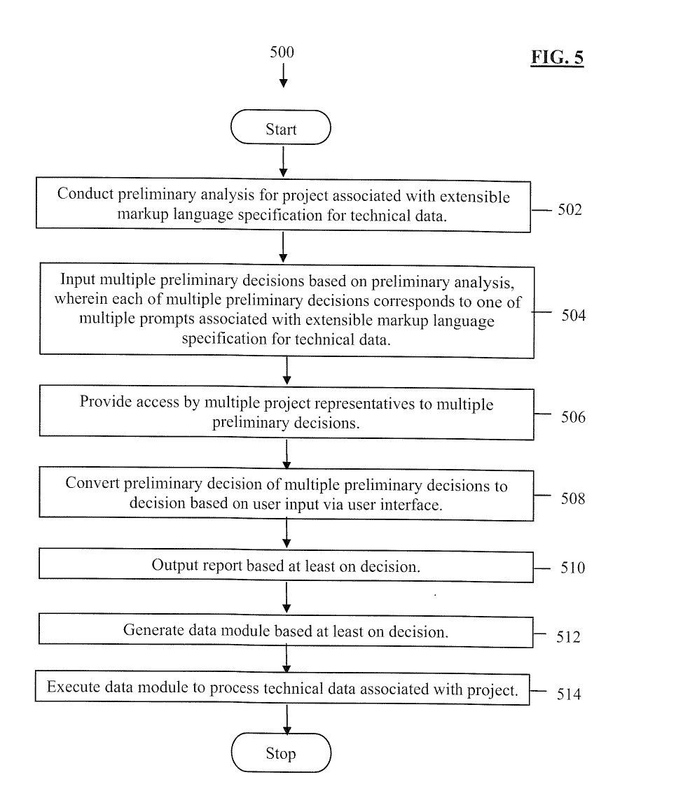

FIG. 5 presents a sample method 500 of the present disclosure. The system 100 may execute the method 500 to customize an XML standard for technical documentation.

In box 502, preliminary analysis is conducted for a project associated with an extensible markup language specification for technical data. For example, the computer program 106 outputs a message via the user interface 108 to an analyst that instructs the analyst to conduct preliminary analysis with the project representatives 110 for an aircraft project.

In box 504, multiple preliminary decisions are input based on preliminary analysis, wherein each of multiple preliminary decisions corresponds to one of multiple prompts associated with extensible markup language specification for technical data. For example, the user interface 108 inputs the preliminary decisions 114 based on the preliminary analysis, such as USA English, no process data modules, and no wiring data description data modules.

In box 506, access by multiple project representatives is provided to multiple preliminary decisions. For example, the user interface 108 provides access by the project representative John Doe to the preliminary decisions 114.

In box 508, a preliminary decision of multiple preliminary decisions is converted to a decision based on user input via a user interface. For example, the computer program 106 converts the preliminary decision for the choice of language to one of the decisions 120 based on John Doe's confirmation via the user interface 108.

In box 510, a report is output based at least on a decision. For example, the computer program 106 outputs a PDF report based on the decisions regarding USA English, no process data modules, and no wiring data description data modules.

In box 512, a data module is generated based at least on a decision. For example, the computer program 106 generates a business rules exchange data module based on the decisions regarding USA English, no process data modules, and no wiring data description data modules.

In box 514, a data module is executed to process technical data associated with a project. For example, a business rules exchange data module, based on the decisions regarding USA English, no process data modules, and no wiring data description data modules, is executed with the XML schema for S1000D™ to process technical data associated with the aircraft project. The method 500 may be repeated as desired.

The systems, methods, and computer program products in the embodiments described above are exemplary. Therefore, many details are neither shown nor described. Even though numerous characteristics of the embodiments of the present disclosure have been set forth in the foregoing description, together with details of the structure and function of the present disclosure, the present disclosure is illustrative, such that changes may be made in the detail, especially in matters of shape, size and arrangement of the components within the principles of the present disclosure to the full extent indicated by the broad general meaning of the terms used in the attached claims. The description and drawings of the specific examples above do not point out what an infringement of this patent would be, but are to provide at least one explanation of how to make and use the present disclosure. The limits of the embodiments of the present disclosure and the bounds of the patent protection are measured by and defined in the following claims.

1. A system for customizing an extensible markup language standard for technical documentation, the system comprising:
a computer;
a memory;
a user interface; and
a computer program stored in the memory and executed by the computer to:
conduct preliminary analysis for a project associated with the extensible markup language specification for technical data,
input, via the user interface, a plurality of preliminary decisions based on the preliminary analysis, wherein each of the plurality of preliminary decisions corresponds to one of a plurality of prompts associated with the extensible markup language specification for technical data,
provide access, via the user interface, for a plurality of project representatives to the plurality of preliminary decisions,
convert a preliminary decision of the plurality of preliminary decisions to a decision based on a user input via the user interface, and
output, via the user interface, a report based at least on the decision.

2. A system as in claim 1, wherein the extensible markup language standard comprises the S1000D™ specification.

3. A system as in claim 1, wherein the computer program conducts preliminary analysis by prompting an analyst to consult with a project representative, wherein the project representative is at least one of a subject matter expert associated with the project, a business manager associated with the project, and a stakeholder associated with the project.

4. A system as in claim 1, wherein a preliminary decision of the plurality of preliminary decisions comprises a request for further analysis.

5. A system as in claim 1, wherein each of the plurality of preliminary decisions corresponds to a phase of the project and the phase of the project corresponds to a subset of the plurality of prompts associated with the extensible markup language specification for technical data.

6. A system as in claim 1, wherein providing access for the plurality of project representatives to the plurality of preliminary decisions is based on acceptance of access-enabling information input via the user interface.

7. A system as in claim 1, wherein providing access for the plurality of project representatives to the plurality of preliminary decisions comprises providing access to a plurality of explanations, wherein each of the plurality of explanations corresponds to one of the plurality of preliminary decisions.

8. A system as in claim 1, wherein the computer program further converts the preliminary decision of the plurality of preliminary decisions to the decision based on a user input via the user interface that confirms the preliminary decision.

9. A system as in claim 1, wherein the computer program further converts the preliminary decision of the plurality of preliminary decisions to the decision based on a user input via the user interface that promotes modifying the preliminary decision to the decision.

10. A system as in claim 1, wherein computer program further conveys, via the user interface, a plurality of statuses, wherein each of the statuses corresponds to one of the plurality of preliminary decisions.

11. A system as in claim 1, wherein the computer program further conveys, via the user interface, a suggestion to modify the preliminary decision, an explanation to retain the preliminary decision, and a confirmation to retain the preliminary decision.

12. A system as in claim 1, wherein the computer program further conveys, via the user interface, a suggestion to correct the decision that promotes a correction of the decision.

13. A system as in claim 1, wherein the computer program further generates a data module based at least on the decision, wherein the data module is executed to process technical data associated with the project.

14. A method for customizing an extensible markup language standard for technical documentation, the method comprising the steps of:
conducting preliminary analysis for a project associated with the extensible markup language specification for technical data;
inputting, by a computer program stored in a memory and executed by a computer, a plurality of preliminary decisions based on the preliminary analysis, wherein each of the plurality of preliminary decisions corresponds to one of a plurality of prompts associated with the extensible markup language specification for technical data;
providing, by the computer program via the user interface, access by a plurality of project representatives to the plurality of preliminary decisions;
converting, by the computer program, a preliminary decision of the plurality of preliminary decisions to a decision based on a user input via the user interface;
generating, by the computer program, a data module based at least on the decision; and
executing the data module to process technical data associated with the project.

15. A method as in claim 14, further comprising outputting, by the computer program via the user interface, a report based at least on the decision.

16. A method as in claim 14, wherein the data module is a business rules exchange data module.

17. A method as in claim 14, wherein the data module is executed in conjunction with execution of an extensible markup language schema associated with the extensible markup language standard for technical documentation.

18. A method as in claim 14, wherein the step of generating, by the computer program, the data module based at least on the decision comprises entering, via the user interface, an extensible markup language path language statement based on the decision.

19. A computer program product for customizing an extensible markup language standard for technical documentation, the computer program product comprising:
a computer readable storage medium storing computer executable program code that, when executed by a processor, causes the computer executable program code to perform a method comprising the steps of:
conducting preliminary analysis for a project associated with the extensible markup language specification for technical data;
inputting a plurality of preliminary decisions based on the preliminary analysis, wherein each of the plurality of preliminary decisions corresponds to one of a plurality of prompts associated with the extensible markup language specification for technical data;
providing access by a plurality of project representatives via the user interface to the plurality of preliminary decisions;
converting a preliminary decision of the plurality of preliminary decisions to a decision based on a user input via the user interface;
outputting, via the user interface, a report based at least on the decision;
generating a data module via based at least on the decision; and
executing the data module to process technical data associated with the project.

20. A computer program product as in claim 19, wherein executing the data module to process technical data associated with the project comprises outputting a prompt to execute the data module.
